(19) United States
(12) Patent Application Publication
(10) Pub. No.: US 2024/0178483 A1
(43) Pub. Date: May 30, 2024

(54) Power Storage Device and Vehicle

(71) Applicant: TOYOTA JIDOSHA KABUSHIKI KAISHA, Toyota-shi Aichi-ken (JP)

(72) Inventors: Tatsuya SHIMIZU, Okazaki-shi Aichi-ken (JP); Katsuya SHIMAZU, Toyota-shi Aichi-ken (JP); Ayaka KAGAMI, Inazawa-shi Aichi-ken (JP); Mutsumi KAWASHIMA, Nisshin-shi Aichi-ken (JP)

(73) Assignee: TOYOTA JIDOSHA KABUSHIKI KAISHA, Toyota-shi Aichi-ken (JP)

(21) Appl. No.: 18/382,788

(22) Filed: Oct. 23, 2023

(30) Foreign Application Priority Data
Nov. 24, 2022 (JP) 2022-187264

(51) Int. Cl. H01M 10/6567; H01M 10/613; H01M 10/625; H01M 50/502

(52) U.S. Cl. CPC H01M 10/6567; H01M 10/613; H01M 10/625; H01M 50/502; H01M 2220/20

(57) ABSTRACT

A power storage device includes: a power storage module; an accommodation case that has an upper surface and that accommodates the power storage module; and an electrical connector provided to be connectable to a vehicle-side electrical connector, and a coolant connector provided to be connectable to a vehicle-side coolant connector, wherein the electrical connector and the coolant connector are each provided to protrude upward from the upper surface, and are arranged side by side with a space being interposed between the electrical connector and the coolant connector, and a flow suppressing portion is provided between the electrical connector and the coolant connector in an arrangement direction in which the electrical connector and the coolant connector are arranged side by side, so as to suppress flow of a coolant from the coolant connector side toward the electrical connector side when the coolant is leaked from the coolant connector.

This nonprovisional application is based on Japanese Patent Application No. 2022-187264 filed on Nov. 24, 2022 with the Japan Patent Office, the entire contents of which are hereby incorporated by reference.

### BACKGROUND

### Field

The present disclosure relates to a power storage device and a vehicle.

### Description of the Background Art

Japanese Patent Application Laid-Open No. 2012-192783 discloses a battery exchange device that replaces a battery mounted on a vehicle with a new battery. The battery exchange device attaches and detaches a battery unit to and from a battery support portion provided in the vehicle from a lower side of the vehicle. The battery exchange device includes a battery mounting portion provided to be movable up and down at a position corresponding to a battery support portion of a vehicle stopped at a vehicle stop portion.

### SUMMARY

In a battery device, a cooling device in which a coolant such as a cooling liquid flows may be used in order to cool a battery disposed in an accommodation case. In this case, in order to connect a cooling circuit provided on the vehicle side to the cooling device, a vehicle-side coolant connector is provided on the vehicle body side. A coolant connector to be connected to the vehicle-side coolant connector is provided on the battery device side.

Further, in order to connect an electrical system on the vehicle side and an electrical system on the battery side, a vehicle-side electrical connector is provided on the vehicle body side. An electrical connector to be connected to the vehicle-side electrical connector is provided on the battery device side.

There is a concern that when the vehicle-side coolant connector and the battery-side coolant connector are not liquid-tightly sealed at the time of replacing the battery device mounted on the vehicle, the coolant leaked from the coolant connector side may reach the electrical connector.

The present disclosure has been made in view of the above-described problem and has an object to provide a power storage device and a vehicle so as to suppress a coolant leaked from a coolant connector side from reaching an electrical connector.

A power storage device according to the present disclosure includes: a power storage module; an accommodation case that has an upper surface and that accommodates the power storage module; and an electrical connector provided to be connectable to a vehicle-side electrical connector, and a coolant connector provided to be connectable to a vehicle-side coolant connector. The electrical connector and the coolant connector are each provided to protrude upward from the upper surface, and are arranged side by side with a space being interposed between the electrical connector and the coolant connector. A flow suppressing portion is provided between the electrical connector and the coolant connector in an arrangement direction in which the electrical connector and the coolant connector are arranged side by side, so as to suppress flow of a coolant from the coolant connector side toward the electrical connector side when the coolant is leaked from the coolant connector.

According to the above configuration, with the flow suppressing portion, the coolant leaked from the coolant connector and flowing on the upper surface of the accommodation case can be suppressed from reaching the electrical connector.

In the power storage device according to the present disclosure, the flow suppressing portion may include a protrusion provided in the upper surface between the electrical connector and the coolant connector so as to extend along a direction intersecting the arrangement direction.

According to the above configuration, the coolant leaked from the coolant connector and flowing on the upper surface of the accommodation case can be stopped by the protrusion.

In the power storage device according to the present disclosure, the flow suppressing portion may be provided with a groove portion provided in the upper surface between the electrical connector and the coolant connector so as to extend along a direction intersecting the arrangement direction.

According to the above configuration, the coolant leaked from the coolant connector and flowing on the upper surface can be stored in the groove portion.

In the power storage device according to the present disclosure, the accommodation case may include a first chamber in which the electrical connector is provided and a second chamber in which the coolant connector is provided. Further, the first chamber and the second chamber may be provided to be separated from each other in the arrangement direction. In this case, the flow suppressing portion is constituted of a clearance formed between the first chamber and the second chamber in the arrangement direction.

According to the above configuration, the coolant leaked from the coolant connector and flowing on the upper surface of the accommodation case can be guided to the clearance.

In the power storage device according to the present disclosure, a frame may be disposed in the clearance to attach the accommodation case to a vehicle body.

According to the above configuration, the power storage device can be more strongly fixed to the vehicle body by utilizing the clearance formed between the first chamber and the second chamber.

A vehicle according to the present disclosure includes: the power storage device; and a vehicle body. The power storage device is detachably attached to the vehicle body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a bottom view of a vehicle according to a first embodiment.

FIG. 2 is a perspective view showing a power storage device mounted on the vehicle according to the first embodiment.

FIG. 3 is a schematic view of a connector structure on a vehicle side connected to a power storage device in the vehicle according to the first embodiment as viewed from a bottom surface side.

FIG. 4 is a front view showing a state in which a vehicle body and a power storage device are connected to each other in the vehicle according to the first embodiment.

FIG. 5 is a front view showing a state in which a vehicle body and a power storage device are connected to each other in a vehicle according to a second embodiment.

FIG. 6 is a front view showing a state in which a vehicle body and a power storage device are connected to each other in a vehicle according to a third embodiment.

FIG. 7 is a front view showing a state in which a vehicle body and a power storage device are connected to each other in a vehicle according to a fourth embodiment.

### DESCRIPTION OF THE EMBODIMENTS

Hereinafter, embodiments of the present disclosure will be described in detail with reference to the drawings. In the following embodiments, the same or common portions are denoted by the same reference numerals, and description thereof will not be repeated.

### Embodiment 1

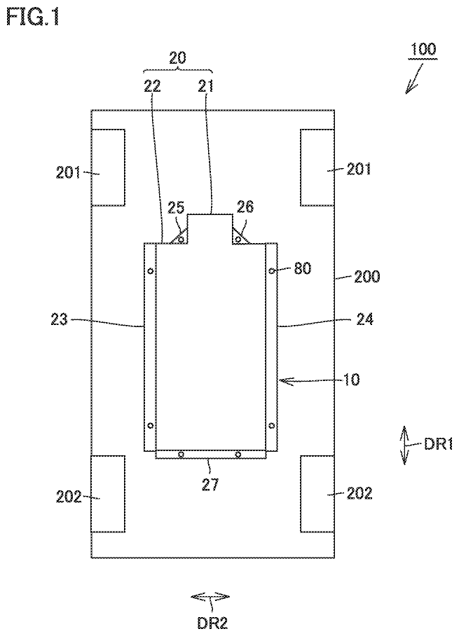

FIG. 1 is a bottom view of a vehicle according to a first embodiment. A vehicle 100 according to a first embodiment will be described with reference to FIG. 1.

The vehicle 100 is a hybrid electric vehicle that can travel by using power of at least one of a motor and an engine, or an electrically powered vehicle that travels by a driving force obtained by electric energy. The vehicle 100 includes a vehicle body 200, a pair of front wheels 201, a pair of rear wheels 202, and a power storage device 10. The power storage device 10 is fixed to the vehicle body 200 by a plurality of fasteners 80 such as bolts.

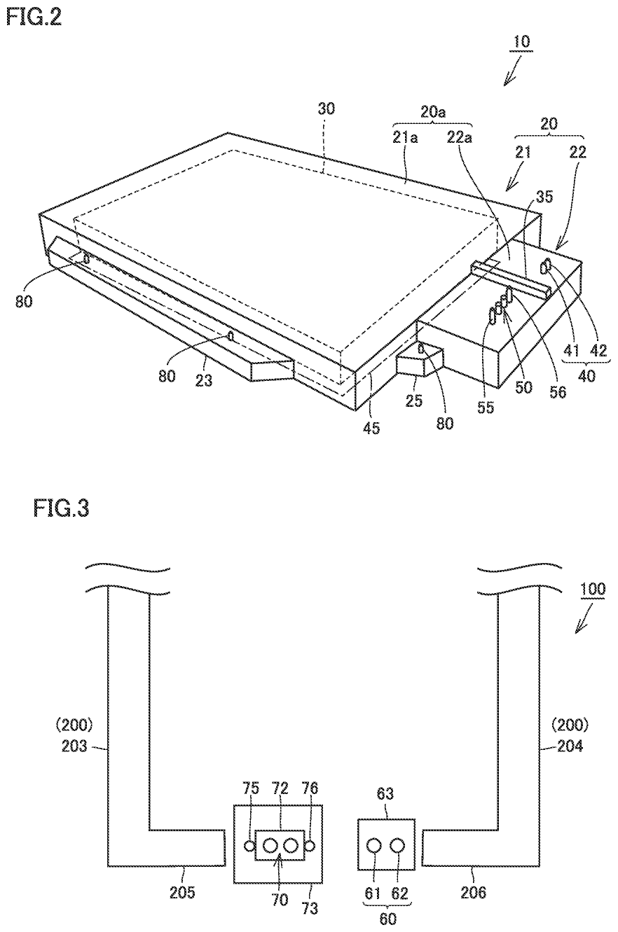

FIG. 2 is a perspective view showing a power storage device mounted on the vehicle according to the first embodiment. A detailed structure of the power storage device 10 will be described with reference to FIGS. 1 and 2.

As shown in FIG. 2, the power storage device 10 includes an accommodation case 20, a power storage module 30, a coolant connector 40, a cooling device 45, an electrical connector 50, an induction connector 55, and a block body 35 serving as a flow suppressing unit.

The power storage module 30 is formed by arranging a plurality of power storage stacks in which power storage cells are arranged in a predetermined direction.

The power storage cell is, for example, a secondary battery such as a nickel-metal hydride battery or a lithium ion battery. The power storage cell may use either a liquid electrolyte or a solid electrolyte. The power storage cell may be a unit capacitor configured to be capable of storing electric power.

The accommodation case 20 houses therein the power storage module 30. The accommodation case 20 has a substantially box shape and has an upper surface 20a. The accommodation case 20 includes a first portion 21 and a second portion 22.

The first portion 21 mainly houses the power storage module 30 and the cooling device 45. The first portion 21 has a substantially rectangular parallelepiped shape whose longitudinal direction is the front-rear direction (the DR1 direction in FIG. 1) of the vehicle. The first portion 21 has an upper surface 21a.

The second portion 22 is provided adjacent to the first portion 21. Specifically, the second portion 22 is provided adjacent to the front side of the first portion 21. The width of the second portion 22 parallel to the width direction of the vehicle (the DR2 direction in FIG. 1) is smaller than that of the first portion 21. The second portion 22 is disposed substantially at the center of the first portion 21 in the width direction.

The second portion 22 has a substantially rectangular parallelepiped shape. The second portion 22 has an upper surface 22a. The upper surface 22a and the upper surface 21a of the first portion 21 constitute an upper surface 20a of the accommodation case 20.

The second portion 22 is provided with a coolant connector 40, an electrical connector 50, induction connectors 55 and 56, and a block body 35 serving as a flow suppressing portion.

The coolant connector 40, the electrical connector 50, and the induction connectors 55 and 56 are provided so as to project upward from the upper surface 22a. The coolant connector 40, the electrical connector 50, and the induction connector 55 are arranged side by side in the width direction.

The electrical connector 50 and the induction connectors 55 and 56 are arranged side by side in the width direction on one side in the width direction. The electrical connector 50 is connected to a vehicle-side electrical connector 70 described later. When the electrical connector 50 and the vehicle-side electrical connector 70 are connected to each other, the electric power can be transferred between the vehicle-side electrical system and the power storage module 30.

The induction connectors 55 and 56 are provided on both outer sides of the electrical connector 50 in the width direction. The induction connectors 55 and 56 engage with vehicle-side induction connectors 75 and 76 (see FIG. 3) described later, whereby the electrical connector 50 and the vehicle-side electrical connector 70 are positioned.

The coolant connector 40 is disposed on one side in the width direction. The coolant connector 40 is connected to a vehicle-side coolant connector 60 (see FIG. 3) described later. The coolant connector 40 is connected to the cooling device 45 inside the accommodation case 20. By connecting the coolant connector 40 and the vehicle-side coolant connector 60, the coolant can be circulated in the cooling device 45.

The coolant connector 40 includes an introduction-side connector 41 and a discharge-side connector 42. The coolant is introduced from the cooling circuit on the vehicle side via the introduction-side connector 41. The coolant introduced through the introduction-side connector 41 passes through the cooling device 45 and is discharged from the discharge-side connector 42 to the cooling circuit on the vehicle side.

The cooling device 45 is disposed below the power storage module 30. The cooling device 45 is provided so as to be able to cool the power storage module 30. The cooling device 45 has a coolant flow path through which coolant flows.

The block body 35 extends, for example, in a direction parallel to the longitudinal direction of the vehicle. The block body 35 may be provided from one end of the upper surface 22a to the other end thereof in a direction parallel to the longitudinal direction of the vehicle.

The block body 35 is disposed between the coolant connector 40 and the electrical connector 50 in the arrangement direction in which the coolant connector 40 and the electrical connector 50 are arranged. The arrangement direction is parallel to the width direction of the vehicle. The block body 35 is provided on the upper surface 22a.

Frames 23, 24, 25, 26, and 27 for fixing to the vehicle body 200 are provided around the accommodation case 20. The frame 23 is provided on a side surface of the first portion 21 on one side in the width direction. The frame 24 is provided on a side surface of the first portion 21 on the other side in the width direction.

The frame 25 is provided on a side surface of the second portion 22 on one side in the width direction and a portion of the front surface of the first portion 21 located on one side in the width direction. The frame 26 is provided on a side surface of the second portion 22 on the other side in the width direction and a portion of the front surface of the first portion 21 located on the other side in the width direction.

The frame 27 is provided on the rear surface of the first portion 21. The frames 23 to 27 are attached to the vehicle body 200 by a plurality of fasteners 80.

FIG. 3 is a schematic view of a connector structure on a vehicle side connected to a power storage device in the vehicle according to the first embodiment as viewed from a bottom surface side. Referring to FIG. 3, a connector on the vehicle 100 side will be described.

As shown in FIG. 3, the vehicle body 200 includes side members 203 and 204. The side members 203 are positioned on one side in the width direction, and the side members 204 are positioned on the other side in the width direction.

The side member 203 is provided with an extension portion 205 extending toward the other side (side member 204 side) in the width direction. The side member 204 is provided with an extension portion 206 extending toward one side in the width direction (the side member 203 side).

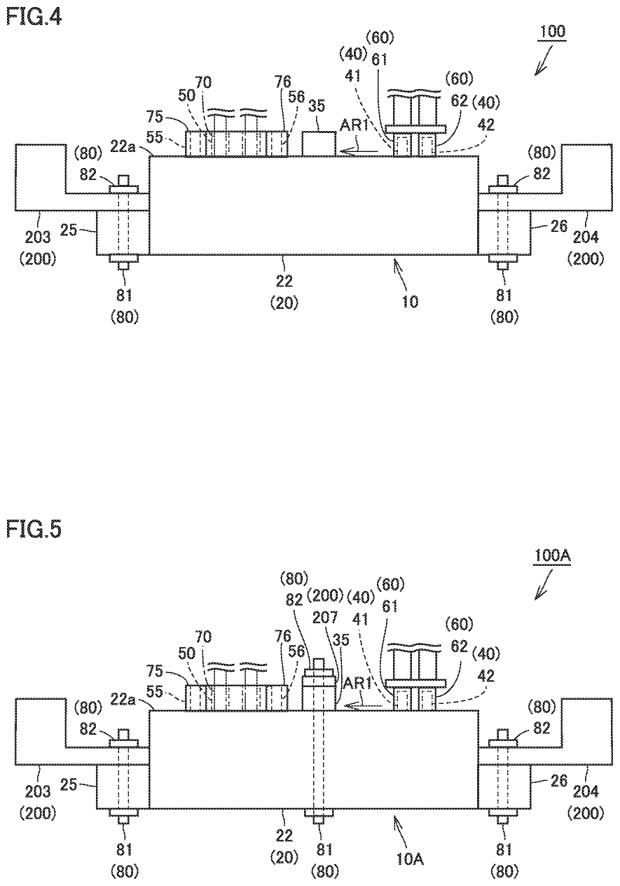

The frame 23 is detachably fixed to the side member 203 by a fastener 80. The frame 24 is detachably fixed to the side member 204 by a fastener 80. The frames 25 and 26 are detachably fixed to the extension portions 205 and 206 by fasteners 80, respectively. The frame 27 is fixed to, for example, a cross member (not shown) provided at the rear of the vehicle body 200 by a fastener 80. The fastener 80 includes a fastening bolt 81 (see FIG. 4) and a nut 82 (see FIG. 4) fixed to the vehicle body 200.

A vehicle-side electrical connector 70, vehicle-side induction connectors 75 and 76, and a vehicle-side coolant connector 60 are disposed in a gap between the extension portions 205 and 206.

The vehicle-side electrical connector 70 is supported by a support portion 73 which is directly or indirectly fixed to the vehicle body 200. The vehicle-side electrical connector 70 is provided so as to project downward from the support portion 73. The support portion 73 is provided with a protection portion 72 for protecting the vehicle-side electrical connector 70. The protection portion 72 is provided so as to surround the vehicle-side electrical connector 70. The vehicle-side induction connectors 75 and 76 are provided on both sides of the protection portion 72 in the width direction.

The vehicle-side coolant connector 60 is supported by a support 63 which is directly or indirectly fixed to the vehicle body 200. The vehicle-side coolant connector 60 includes a vehicle-side introduction connector 61 and a vehicle-side discharge connector 62.

When the power storage device 10 is replaced with a new power storage device 10, the fastening bolt 81 is loosened by the replacement device to remove the power storage device 10. Subsequently, the power storage device 10 is moved to the storage location, and the new power storage device 10 that has been waiting at the standby position is transported to a predetermined mounting position. Subsequently, the power storage device 10 is moved upward toward the vehicle body from the mounting position by the exchange device. At this time, the coolant connector 40 and the electrical connector 50 provided in the new power storage device 10 are connected to the vehicle-side coolant connector 60 and the vehicle-side electrical connector 70. Further, the fastening bolt 81 is inserted into a nut 82 fixed to the vehicle body 200, and the fastening bolt 81 is rotated by a replacement device, whereby the power storage device 10 is fixed to the vehicle body 200.

FIG. 4 is a front view showing a state in which a vehicle body and a power storage device are connected to each other in the vehicle according to the first embodiment.

As shown in FIG. 4, when the vehicle body 200 and the power storage device 10 are connected to each other, the vehicle-side electrical connector 70 is inserted into the electrical connector 50, and the coolant connector 40 is inserted into the vehicle-side coolant connector 60.

Generally, in the case that the vehicle-side coolant connector 60 and the coolant connector 40 on the power storage device 10 side are not sealed in a liquid-tight manner when the battery device mounted on the vehicle is replaced, the coolant leaked from the coolant connector 40 side may flow toward the electrical connector 50 along the upper surface 22a as shown by an arrow AR1. In this case, even if the protection portion 72 is provided, there is a concern that the coolant entering from between the protection portion 72 and the upper surface 22a reaches the electrical connector 50.

In the present embodiment, the block body 35 is provided between the electrical connector 50 and the coolant connector 40 in the arrangement direction in which the electrical connector 50 and the coolant connector 40 are arranged. Therefore, even when the coolant leaks from the coolant connector 40 side, the coolant is blocked by the block body 35. Thereby, it is possible to suppress the leaked coolant from reaching the electrical connector 50. As a result, short circuit of the power storage module 30 can be suppressed.

In the embodiment, the case where the block body 35 stops the flow of the coolant on the upper surface 22a has been described as an example, but the present disclosure is not limited thereto. Instead of the block body 35, a protrusion for stopping the flow of the coolant may be provided so as to project upward from the above-mentioned 22a. The extending direction of the block body 35 is not limited to a direction parallel to the longitudinal direction of the vehicle, and may be a direction intersecting with the arrangement direction.

### Embodiment 2

FIG. 5 is a front view showing a state in which a vehicle body and a power storage device are connected to each other in a vehicle according to a second embodiment. A vehicle 100A according to a second embodiment will be described with reference to FIG. 5.

As shown in FIG. 5, the vehicle 100A according to the second embodiment differs from the vehicle 100 according to the first embodiment in the configurations of the vehicle body 200 and the power storage device 10A. Specifically, the present embodiment is different from the first embodiment in that the power storage device 10 is attached to the vehicle body 200 in a state where the block body 35 is in contact with the fixed portion 207 which is a part of the vehicle body. The other points are substantially the same.

The vehicle 100A includes a fixed portion 207 between the vehicle-side electrical connector 70 and the vehicle-side coolant connector 60. A nut 82 is fixed to the fixed portion 207. An insertion hole through which the fastening bolt 81 can be inserted is formed in the second portion 22, the block body 35, and the fixed portion 207 of the accommodation case 20.

By inserting the fastening bolts 81 into the respective insertion holes and fastening them to the nuts 82, the power storage device 10 can be more strongly fixed to the vehicle body 200. Further, the flow suppressing portion can be constituted by the block body 35 and the fixed portion 207. By bringing the fixed portion 207 into contact with the upper surface of the block body 35, the height of the flow suppressing portion can be increased. Thus, even when the coolant leaks from the coolant connector 40 side, the coolant can be more reliably blocked by the flow restraining portion.

### Embodiment 3

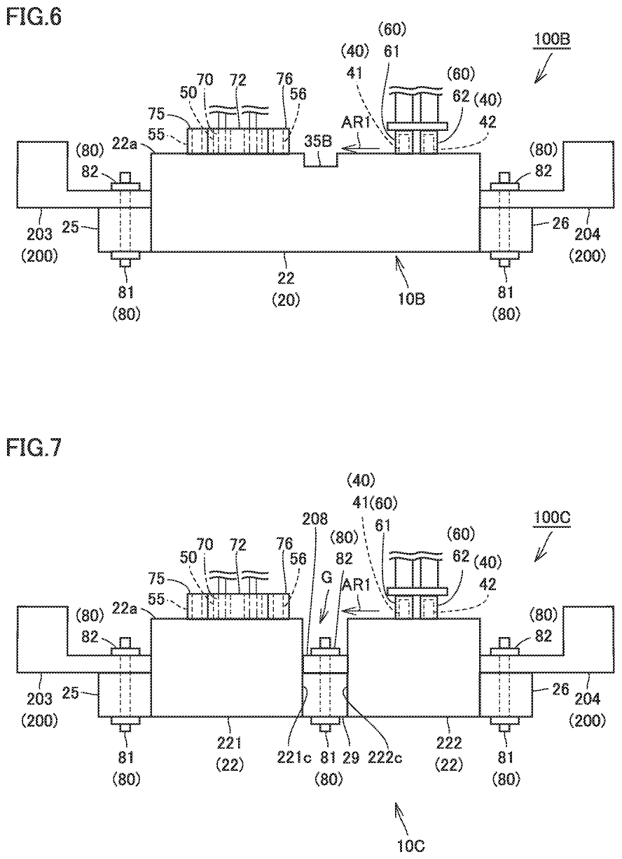

FIG. 6 is a front view showing a state in which a vehicle body and a power storage device are connected to each other in a vehicle according to a third embodiment.

As shown in FIG. 6, the vehicle 100B according to the third embodiment is different from the vehicle 100 according to the first embodiment in the configuration of the power storage device 10B. Specifically, the third embodiment is different from the block body 35 according to the first embodiment in that a groove portion 35B is provided as a flow suppressing portion. Other configurations are substantially the same.

The groove portion 35B is disposed between the coolant connector 40 and the electrical connector 50 in the arrangement direction in which the coolant connector 40 and the electrical connector 50 are arranged. The groove portion 35B is provided on the upper surface 22a. The groove portions 35B are provided so as to extend along the intersecting direction intersecting with the arrangement direction.

When the coolant leaks from the coolant connector 40 side, the coolant can be stored by the groove portion 35B. Thereby, it is possible to suppress the coolant from reaching the electrical connector 50.

Further, the groove portion 35B may be provided so as to extend to an end portion of the second portion 22 located on the side farther from the first portion 21 side in the direction in which the first portion 21 and the second portion 22 of the accommodation case 20 are arranged. In this case, the coolant entering the groove portion 35B from the end portion can be discharged to the outside of the accommodation case 20. Further, the groove portion 35B may be provided so as to be inclined downward with increasing distance from the first portion 21 in the intersecting direction. In this case, it is possible to more reliably discharge the coolant leaked from the coolant connector 40 side to the outside of the accommodation case 20 by utilizing the inclination.

### Embodiment 4

FIG. 7 is a front view showing a state in which a vehicle body and a power storage device are connected to each other in a vehicle according to a fourth embodiment. A vehicle 100C according to a fourth embodiment will be described with reference to FIG. 7.

As shown in FIG. 7, the vehicle 100C according to the fourth embodiment differs from that of the first embodiment in the configurations of the vehicle body 200 and the power storage device 10C. Specifically, the configuration of the accommodation case 20 and the point that the fixed portion 208 is provided in the vehicle body are different. The other configurations are substantially the same.

The accommodation case 20 includes a first chamber 221 in which the electrical connector 50 is provided and a second chamber 222 in which the coolant connector 40 is provided. The first chamber 221 and the second chamber 222 are provided in the second portion 22.

The first chamber 221 and the second chamber 222 are spaced apart from each other in the arrangement direction in which the coolant connector 40 and the electrical connector 50 are arranged. The first chamber 221 has a side surface 221c positioned on the second chamber 222 side. The second chamber 222 has a side surface 222c positioned on the first chamber 221 side.

A gap G is provided between the first chamber 221 and the second chamber 222 (more specifically, between the side surface 221c and the side surface 222c). The gap G constitutes a flow suppressing portion. In this case, the coolant flowing from the coolant connector 40 side through the upper surface 22a can escape to the gap G. This suppresses the coolant from reaching the electrical connector 50.

A frame 29 for attaching the accommodation case 20 to the vehicle body 200 is provided in the space G. The frame 29 is positioned between the side surface 221c of the first chamber 221 and the side surface 222c of the second chamber 222, and is fixed to the lower side of the side surface 221c and the side surface 222c.

The vehicle body 200 has a fixed portion 208 so as to be positioned in the gap G between the first chamber 221 and the second chamber 222. The fixed portion 208 is provided below the upper surface 22a.

A nut 82 is fixed to the fixed portion 208. The frame 29 and the fixed portion 208 are provided with insertion holes through which the fastening bolts 81 can be inserted. By inserting the fastening bolt 81 into each insertion hole and fastening the fastening bolt 81 to the nut 82, the power storage device 10 can be fixed to the vehicle body 200 more strongly.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a power storage module;
an accommodation case that has an upper surface and that accommodates the power storage module; and
an electrical connector provided to be connectable to a vehicle-side electrical connector, and a coolant connector provided to be connectable to a vehicle-side coolant connector, wherein
the electrical connector and the coolant connector are each provided to protrude upward from the upper surface, and are arranged side by side with a space being interposed between the electrical connector and the coolant connector, and
a flow suppressing portion is provided between the electrical connector and the coolant connector in an arrangement direction in which the electrical connector and the coolant connector are arranged side by side, so as to suppress flow of a coolant from the coolant connector side toward the electrical connector side when the coolant is leaked from the coolant connector.

2. The power storage device according to claim 1, wherein the flow suppressing portion includes a protrusion provided in the upper surface between the electrical connector and the coolant connector so as to extend along a direction intersecting the arrangement direction.

3. The power storage device according to claim 1, wherein the flow suppressing portion is provided with a groove portion provided in the upper surface between the electrical connector and the coolant connector so as to extend along a direction intersecting the arrangement direction.

4. The power storage device according to claim 1, wherein
the accommodation case includes a first chamber in which the electrical connector is provided and a second chamber in which the coolant connector is provided,
the first chamber and the second chamber are provided to be separated from each other in the arrangement direction, and
the flow suppressing portion is constituted of a clearance formed between the first chamber and the second chamber in the arrangement direction.

5. The power storage device according to claim 4, wherein a frame is disposed in the clearance to attach the accommodation case to a vehicle body.

6. A vehicle comprising:
the power storage device according to claim 1; and
a vehicle body, wherein
the power storage device is detachably attached to the vehicle body.
